(19) United States
(12) Patent Application Publication
(10) Pub. No.: US 2026/0014528 A1
(43) Pub. Date: Jan. 15, 2026

(54) Ordered Metal Organic Framework Polymer Membranes

(71) Applicant: University of Connecticut, Farmington, CT (US)

(72) Inventors: Yang Qin, Mansfield Center, CT (US); Sebastian DiMauro, Mansfield Center, CT (US)

(73) Assignee: University of Connecticut, Farmington, CT (US)

(21) Appl. No.: 19/268,581

(22) Filed: Jul. 14, 2025

Related U.S. Application Data
(60) Provisional application No. 63/670,195, filed on Jul. 12, 2024.

(51) Int. Cl. B01D 71/02; B01D 53/22; B01D 63/10; B01D 69/06; B01D 69/12; B01D 71/48; B01D 71/50; B01D 71/64

(52) U.S. Cl. CPC B01D 71/022; B01D 53/228; B01D 63/10; B01D 69/06; B01D 69/125; B01D 71/48; B01D 71/50; B01D 71/64

(57) ABSTRACT

A composite membrane that includes a polymeric substrate that defines a plurality of pores and a metal organic framework formed within the pores of the substrate. The metal organic framework is formed through interfacial synthesis of an aqueous metal ion and an organic ligand solution within the pores of the substrate. Methods for membrane synthesis are provided that may include a first growth phase and a second growth phase within the pores of the polymeric substrate. The composite membranes may be incorporated into a housing/module for use in gas separation, e.g., in gas separation facilities, including flue gas sorption plants, direct air capture plants, natural gas sweetening pipelines, and olefin/paraffin separation towers.

### BACKGROUND OF THE INVENTION

### 1. Cross-Reference to Related Application

The present application claims priority benefit to a U.S. provisional patent application entitled “Ordered Metal Organic Framework Polymer Membranes,” which was filed on Jul. 12, 2024, and assigned Ser. No. 63/670,195. The entire content of the foregoing U.S. provisional patent application is incorporated herein by reference.

### 2. Field of the Invention

The invention disclosed herein relates to membranes and, in particular, to a composite membrane system and methods of fabrication.

### 3. Description of the Related Art

Carbon capture from flue gas and directly from air is currently commercially implemented by using aqueous amine solutions and alkaline adsorbents, respectively. Carbon dioxide is adsorbed through chemical reactions with these highly caustic chemicals and is released through thermal treatment that also regenerate the adsorbents. However, this regeneration process is energy intensive and requires a large facility footprint incurring high operation cost, which frequently leads to degradation of the adsorbents.

Membrane technology for gas separation applications is an attractive candidate to replace high energy separation methods, such as distillation, due to the high efficiency and low footprint production for carbon capture, biogas separation, and olefin/paraffin separation. Polymer membranes have yet to dominate the separation market stemming from the intrinsic trade-off between permeability and selectivity described by the so-called Robeson upper bound. In attempts to break the upper-bound, several synthetic strategies have been explored, such as polymers of intrinsic microporosity (PIMs), thermally rearranged (TR) polymers, facilitated transport, and mixed-matrix membranes (MMMs).

Polymer membranes have also been implemented, although to a lesser extent, because of comparably less efficiency. Although gas separation by membranes have been recognized as a superior technology than cryogenic distillation and adsorbent technologies due to their lesser requirements for energy and operation cost, state-of-the-art membranes separate molecules through solution-diffusion mechanisms that suffer from compromises between selectivity and permeability. For separation of CO₂ and N₂, these membranes have not shown selectivity over 100.

Generally, and with reference to FIG. 2, the Robeson correlation is an empirical plot that shows a tradeoff between selectivity and permeability of gases whose upper boundary is often used to evaluate the performance of a membrane system. Robeson discovered a strong correlation of the selectivity of pure, light gas pairs in polymeric membranes with the permeability of the faster permeating gas. The selectivity of a gas pair is α_{A/B}=P_{A}/P_{B} where Pᵢ is the permeability of a pure gas across a dense polymer film defined by volumetric flux per unit driving force for a given thickness. The collection of numerous experimental data showed an upper bound, well defined by a straight line on a log-log plot of α_{A/B} as a function of P_{A}. The slope of the upper bound, −1/n, was shown to be linearly correlated with the difference of kinetic diameter of the gases, Δ_{A/B}=d_{B}−d_{A}, where α_{A/B}=k_{-1/n}p^{1/n}_{A}. Two relevant gas pairs, N₂/CH₄ and CO₂/N₂ were included in the analysis. Overall, the greatest changes regarded revising the front factor k were attributed to higher selectivities for many gas pairs with perflourinated polymers.

Thus, what are needed are methods and apparatus to improve separation of gases, e.g., CO₂ and N₂, in an efficient and scalable manner.

### SUMMARY

A composite membrane is provided that includes a polymeric substrate defining a plurality of pores and a metal organic framework formed within the pores of the substrate. The metal organic framework may be formed through interfacial synthesis of an aqueous metal ion and an organic ligand solution within the pores of the substrate. Methods for membrane synthesis are provided that may include a first growth phase and a second growth phase within the pores of the polymeric substrate. The composite membranes may be incorporated into a housing/module for use in gas separation, e.g., in gas separation facilities, including flue gas sorption plants, direct air capture plants, natural gas sweetening pipelines, and olefin/paraffin separation towers.

In an aspect, a composite membrane is provided that includes (i) a polymeric substrate that defines a plurality of pores that extend therethrough; and (ii) a metal organic framework that includes one or more interfacially synthesized components formed within the plurality of pores. The interfacially synthesized component(s) include a first interfacially synthesized component formed from synthesis of a first aqueous metal ion solution including a single metallic ion and a first organic ligand solution. In an aspect, the interfacially synthesized component(s) may include a second interfacially synthesized component formed from synthesis of a second aqueous metal ion solution and a second organic ligand solution.

In an aspect, the polymeric substrate may be a track-etched polymer template. The aqueous metal ion solution may include, for example, at least one of Zn ions and Co ions. The organic ligand solution may include, for example, a 2-methylimidazole (2-MIM) solution.

In an aspect, the first aqueous metal ion solution and/or the second aqueous metal ion solution may includes bimetallic ions.

In an aspect, the polymeric substrate may be fabricated from a polycarbonate material, a polyester material or a polyimide material. The pores may have a diameter, for example, of 10 nm, 30 nm, 50 nm, 100 nm, 200 nm, 800 nm, 1 μm, 2 μm, 10 μm, and 20 μm. The diameters may be uniform or non-uniform.

In an aspect, at least one of the first aqueous metal ion solution and the optional second aqueous metal ion solution includes at least one of Zn ions and Co ions. The first aqueous metal ion solution and/or the optional second aqueous metal ion solution may include a metallic counterion selected from the group consisting of NO₃⁻, SO₄²⁻, Br⁻, Cl⁻, I⁻, PO₄³⁻, ClO₄⁻, PF₆⁻, CH₃COO⁻, and HCOO⁻.

In an aspect, at least one of the first organic ligand solution and the optional second organic ligand solution may include 2-methylimidazole (2-MIM) solution.

In an aspect, the composite membrane may take the form of a sheet or a spiral wound membrane.

In an aspect, a method for membrane synthesis is provided that includes (i) providing a polymeric substrate that defines a plurality of pores that extend therethrough; (ii) initiating a first growth phase by exposing a first surface of the polymeric substrate to a first aqueous metal ion solution, and exposing a second surface of the polymeric substrate opposite the first surface to a first organic ligand solution; and (iii) optionally initiating a second growth phase by exposing the first surface of the polymeric substrate to a second organic ligand solution, and exposing a second surface of the polymeric substrate opposite the first surface to a second aqueous metal ion solution. The first growth phase and, optionally, the second growth phase effectuate interfacial synthesis of a metal organic framework (MOF) within the plurality of pores.

In an aspect, the method includes rinsing and drying of the polymeric substrate between the first growth phase and the optional second growth phase.

In an aspect, the first aqueous metal ion solution and the optional second aqueous metal ion solution may include the same metal ions in solution. In an aspect, the first organic ligand solution and the optional second organic ligand solution may include the same organic linker chemical(s) in solution.

In an aspect, the first aqueous metal ion solution in the first growth phase may include a single metal ion, and the second aqueous metal ion solution in the optional second growth phase may be bimetallic.

In an aspect, the polymeric substrate may be positioned within a reaction chamber during the first growth phase and the optional second growth phase. The reaction chamber may include a plurality of ports that permit introduction and withdrawal of the first aqueous metal ion solution, the optional second aqueous metal ion solution, the first organic ligand solution and the optional second organic ligand solution therefrom.

The first growth phase and the optional second growth phase yield a composite membrane.

In an aspect, a method for separating gases is provided that includes: (i) exposing a composite membrane as described herein to a mixture of gases; and (ii) separating a first gas included in the mixture of gases from a second gas included in the mixture of gases by molecular sieving of the first gas from the second gas with the composite membrane.

In an aspect, a module is provided for use in a gas separation application that includes a housing and a composite membrane positioned within the housing. The composite membrane includes: (i) a polymeric substrate that defines a plurality of pores that extend therethrough; and (ii) a metal organic framework that includes one or more interfacially synthesized components formed within the plurality of pores. The interfacially synthesized component(s) include (i) a first interfacially synthesized component formed from synthesis of a first aqueous metal ion solution including a single metallic ion and a first organic ligand solution, and (ii) optionally, a second interfacially synthesized component formed from synthesis of a second aqueous metal ion solution and a second organic ligand solution

Additional features, functions and benefits of the composite membranes and methods of manufacture/use will be apparent from the description which follows, particularly when read in conjunction with the accompanying figures.

### BRIEF DESCRIPTION OF THE DRAWINGS

The features and advantages of the invention are apparent from the following description taken in conjunction with the accompanying drawings in which:

FIG. 1 is a schematic diagram depicting aspects of membrane synthesis;

FIG. 2 is a plot with the Robeson upper bound for CO₂/N₂ separation with compiled performance data for existing membranes;

FIGS. 3A and 3B are tables that include performance data for a series of membrane samples;

FIG. 4 is a plot of performance data for a series of membrane samples;

FIGS. 5A, 5B, 5C and 5D are tables of performance data for a series of membrane samples;

FIG. 6 is a plot of performance data for a series of membrane samples;

FIGS. 7A and 7B are tables of performance data for a pair of membrane samples;

FIG. 8 is a plot of performance data for a membrane sample;

FIGS. 9A and 9B are tables of performance data for a series of membrane samples;

FIG. 10 is a plot of performance data for a series of membrane samples;

FIGS. 11A-11D are schematic depictions of a continuous/semi-continuous system for membrane synthesis.

### DETAILED DESCRIPTION OF THE INVENTION

Disclosed herein are composite membrane system, and methods for fabrication of composite membrane systems. The resulting membranes display gas separation performance superior to existing membrane technologies.

Metal Organic Frameworks (MOFs) are a class of solid porous materials, which consist of metal ions or metallic clusters, which act as nodes, and polydentate organic ligands, which act as linkers between the nodes. (MOFs) may take the form of microporous crystalline material in which metal ions or clusters are connected via organic linkers producing high surface area, pore volume, and tunable pore structures and surface functionality. The customizability of MOFs has allowed for a myriad of potential applications including catalysis, drug delivery, conductivity, gas storage, and gas/liquid separations.

Zeolitic imidazole frameworks (ZIFs) are a subclass of MOFs that are tetrahedrally coordinated forming a sodalite, chabazite, and linde type A cage structure. ZIF-8 has received attention for its propylene (˜4.0 Å)/propane (˜4.3 Å) separation capabilities since diffusion based determination of its effective pore size exists between 4.0-4.2 Å. Selectivities for mixed gas separations have been observed as high as 50 for pure ZIF-8 films. Membrane modifications have shown promise in the case for CO₂ (3.3 Å)/N₂ (3.6 Å) utilizing CF₃COO— to fix the rotation of 2-methyl imidazole ligand, preventing pore expansion and retention of the XRD measured 3.4 Å pore window affording separation and permeance of 137 and 286 Barrer, respectively.

In aspects of the present disclosure, composite membranes are fabricated by an easy-to-scale up interfacial synthesis modality and operate through a sharp molecular sieving mechanism. In aspects, composite membranes are provided that achieve CO₂/N₂ selectivity over 1000 and CO₂ permeability over 1000 Barrer. In comparison, existing membranes, commercialized or in development, do not display selectivity over 100. Performance of composite membranes fabricated according to aspects is well above Robeson's upper bound, supporting large scale industrial applications.

The composite membrane systems can be provided in a variety of physical forms. For example, embodiments of membranes may be provided as large-area flat sheet and/or spiral wound modules. Embodiments may be used for CO₂ capture applications, including flue gas capture, direct air capture, and natural gas sweetening, with minimum energy input and operation cost. Implementation of composite membranes according to the present disclosure can have far-reaching impact on green-house gas control, negative emission technology, and help to combat global warming and climate change.

In aspects, the membrane systems operate to separate carbon dioxide from flue gas and methane, and a variety of other gases, through molecular sieving effects. Gas separations may be performed in a continuous fashion with minimum energy input as needed to maintain a partial pressure difference across the membrane. In aspects, the membranes can be applied as flat sheet modules and/or spiral wound modules that are compact, low maintenance and easily adapted for a variety of configurations and applications.

Membranes disclosed herein display sharp molecular sieving effects while maintaining flexibility, processability, and adaptability of polymer membranes. In aspects, interfacial synthesis may use commercially available track-etched polymer templates and, in a controlled manner, may grow metal-organic framework (MOF) nanocrystals within the membrane pores defined by the track-etched polymer templates. In an aspect, the synthesis methods yield an ordered MOF at polymer mixed-matrix membrane (MMM). The resultant ordering integrates synergistically the properties and functions from the hard MOF and soft polymer components into a composite membrane. As such, the polymer template facilitates/delivers processability, flexibility, and stability, while the MOF channels afford sharp molecular sieving, e.g., for CO₂ capture from N₂ and CH₄. In aspects, composite membranes display CO₂/N₂ selectivity an order of magnitude higher than best-performing polymer membranes and comparable permeability, which is well above the widely applied Robeson upper bound in membrane research.

Complementing each other, polymer substrates are loaded with MOF filler increasing the performance of the polymer membrane while maintaining the stable and flexible properties of polymer membranes. Polycarbonate track etch (PCTE) membranes are thin, translucent, microporous films that are used in a variety of applications. They are generally made from a polycarbonate material and have pores, e.g., cylindrical pores, that extend through the membrane. PCTE membranes are known for many properties, including hydrophobicity, low surface tension fluids, like alcohols, can fill the pores of hydrophobic membranes, allowing water to pass through and displace the fluid. PCTE membranes are generally biologically inert, chemically resistant, thermally stable, weight stable, exhibit low non-specific binding, and negligible absorption/adsorption of filtrates.

For example, in an aspect, MOF UIO-66 has been incorporated into poly (ethylene glycol) diacrylate (PEGDA) polymer, increasing performance of CO₂/N₂ permeability four-fold, reaching 470 Barrer, while maintaining the selectivity consistent with the pure polymer substrate (41). Likewise, UIO-66-NH₂ incorporated into polyimide capped with ionic liquid has achieved high selectivity for CO₂/CH₄ separation as high as 95.1, while CO₂ permeability was unaffected. In the case of CO₂ separation, industrial standards are most interested in high permeability membranes with selectivity of ˜30.

In an aspect, a hybrid approach to the MMM is undertaken. In an exemplary synthesis according to the present disclosure, ordered bimetallic MOF structures via initial ZIF-8 pore seeding and subsequent bimetallic Zn²⁺/Co²⁺ seeding and interfacial synthesis within a 7 μm thick polycarbonate track etch (PCTE) membrane are synthesized. In an aspect, bimetallic ZIF-8@ZIF-8/67 membranes exhibited exceptional sieving of CO₂ from N₂ with excellent selectivity and permeability.

The membranes may be treated to control properties such as hydrophobicity. For example, agents may be used to adjust hydrophilic properties. Examples of materials useful for creating the PCTE component include, without limitation, polysulfone (PSF), polyethersulfone (PES), polyvinylidene fluoride (PVDF), cellulose acetate (CA), poly-acrylonitrile (PAN), polyimide, polyvinyl alcohol, polytetrafluoroethylene (PTFE), polypropylene (PP), polyvinyl chloride, and cellulose nitrate, alone or in combination, are being used in the preparation of polymeric membranes.

### Experimental Studies

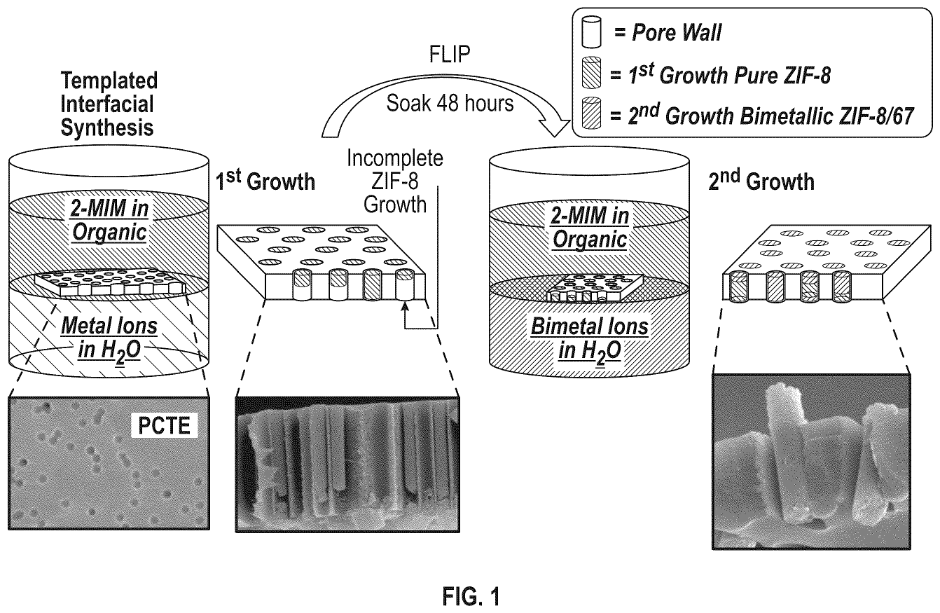

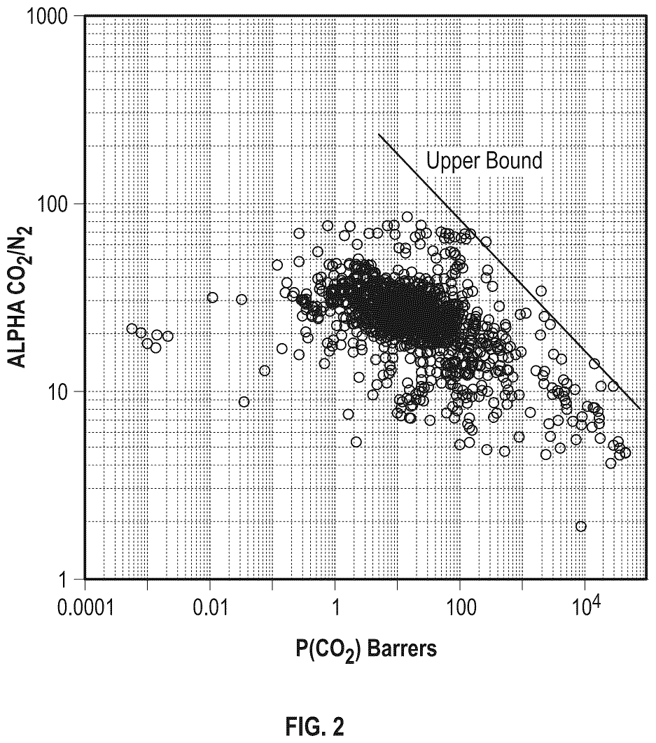

With reference to the schematic diagram of FIG. 1, templated interfacial synthesis was undertaken, as follows. Respective molar concentrations of Zn(NO₃)₂ were dissolved in DI water and porous polymer membranes (track-etched PCTE) placed on the water surface for 1 hour. Respective molar concentration of 2-methylimidazole (2-MIM) was dissolved in 1-octanol and added to the top layer of the membrane. Interfacial synthesis was allowed to proceed for 4 hours. Membranes were then removed, rinsed with DI water and then flipped upside down and placed into respective molar concentrations of bimetal Zn/Co (NO₃)₂ solutions for 48 hours. Following the soaking period, 2-MIM dissolved in 1-octanol was added to the top surface and interfacial synthesis occurred for 4 hours. Membranes were removed and rinsed with DI water, then air dried for 48 hours before testing.

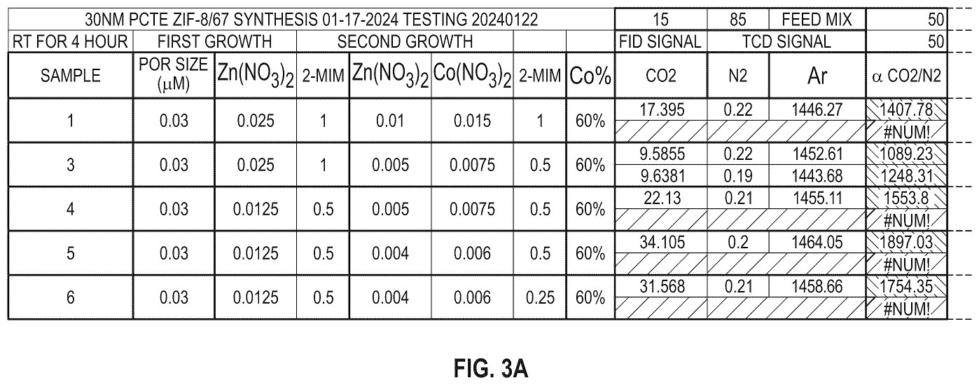

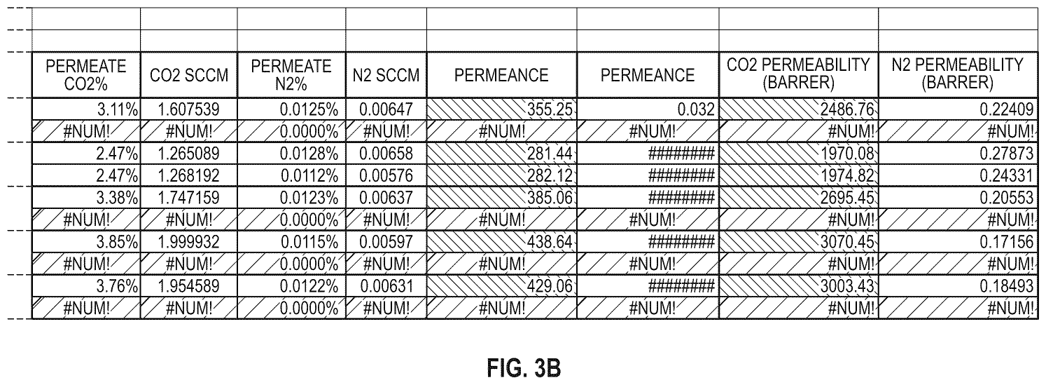

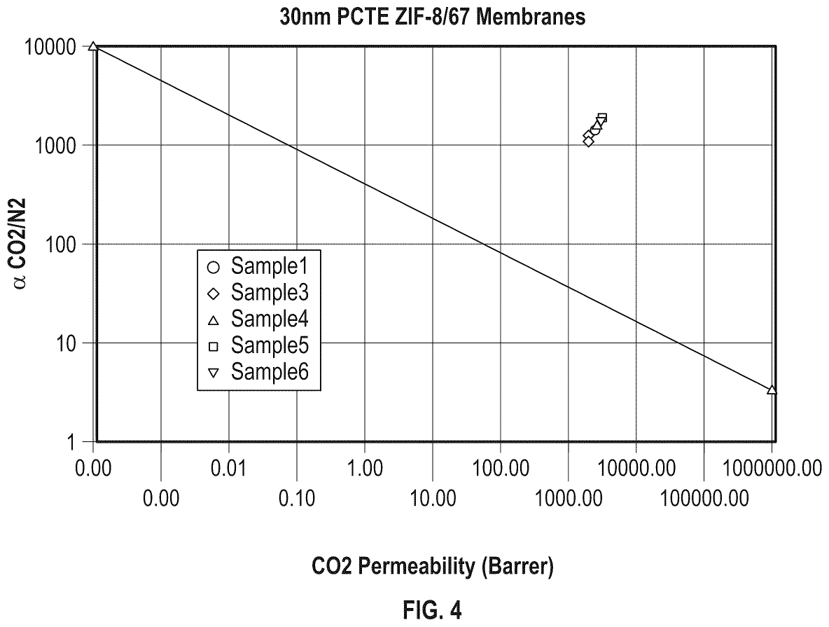

With reference to FIGS. 3 and 4, the PCTE membranes featured 30 nm pores. As shown in the table of FIG. 3, the CO₂ permeability was uniformly above 1000 (ranging from 1089.23 to 1897.03) and the permeance ranged from 281.44 to 438.64. As depicted in the plot of FIG. 4, all six (6) samples for PCTE membranes featuring 30 nm pores far exceeded the Robeson upper bound.

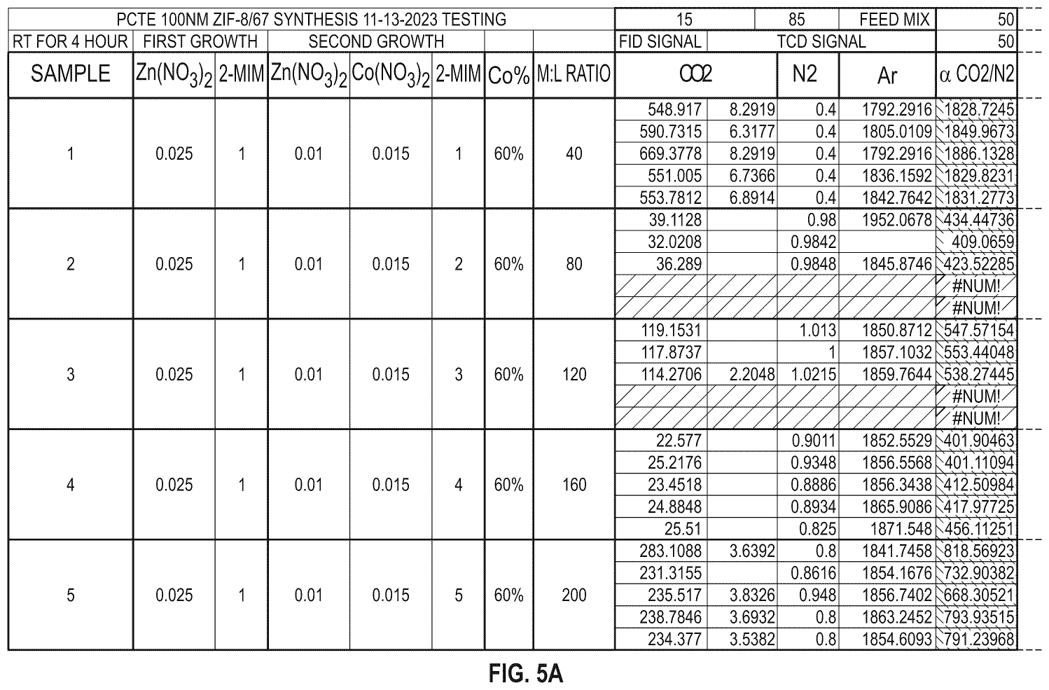

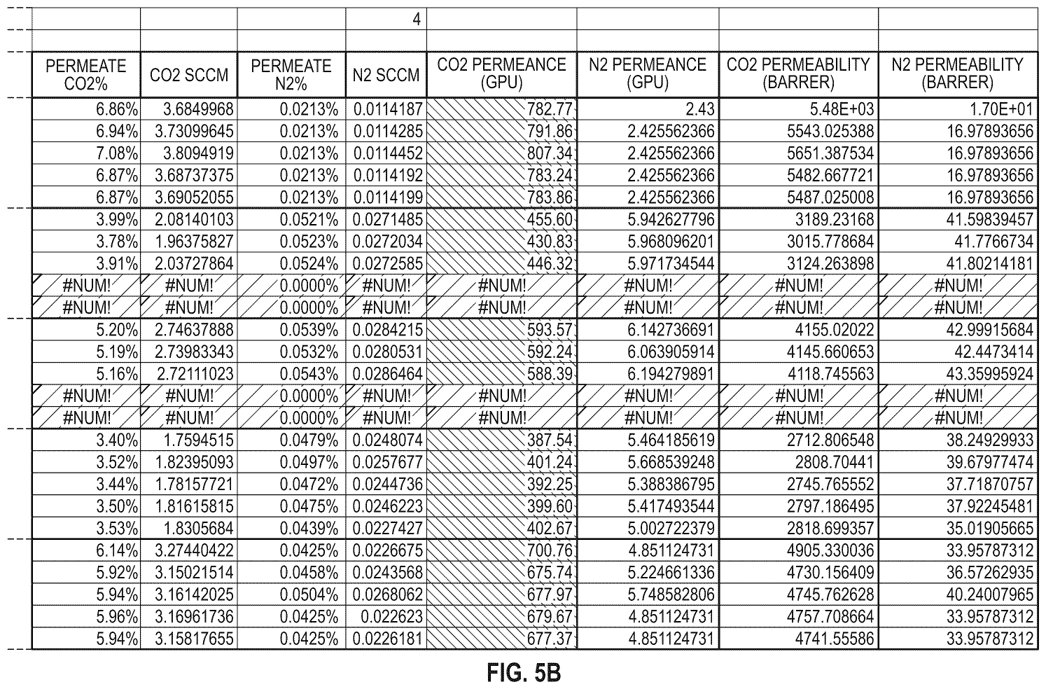

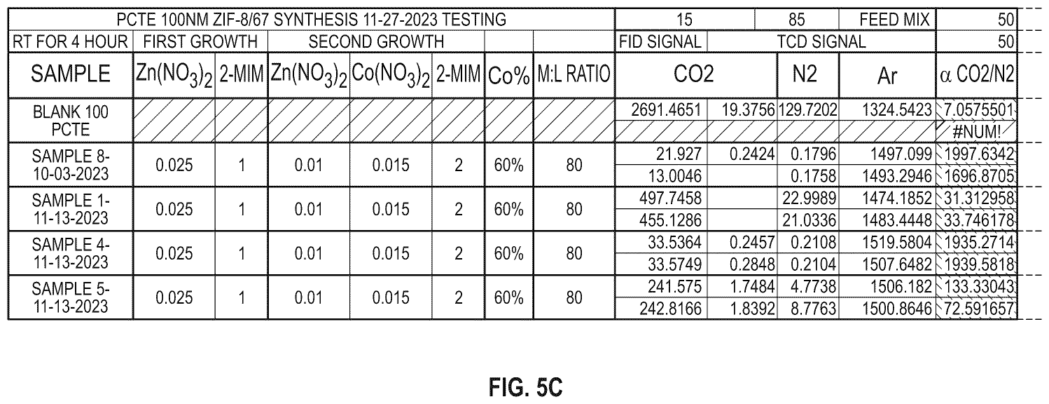

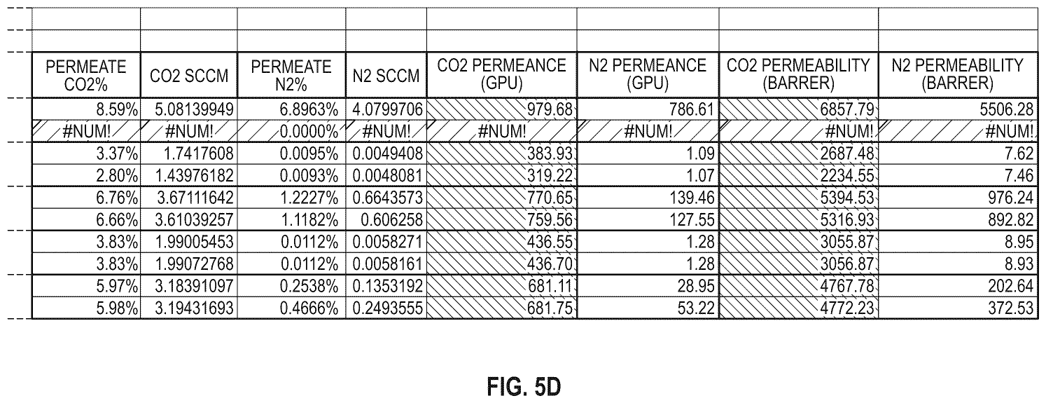

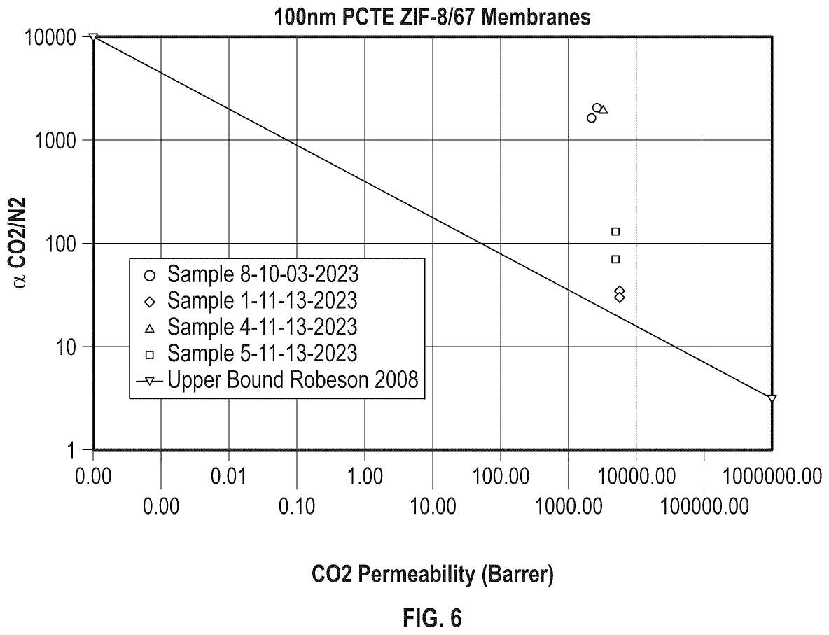

With reference to FIGS. 5 and 6, the PCTE Membranes featured 100 nm pores. As shown in the table of FIG. 5, the CO₂ permeability exceeded 1000 for samples 4 and 8, and, as shown in the plot of FIG. 6, uniformly exceeded the Robeson upper bound.

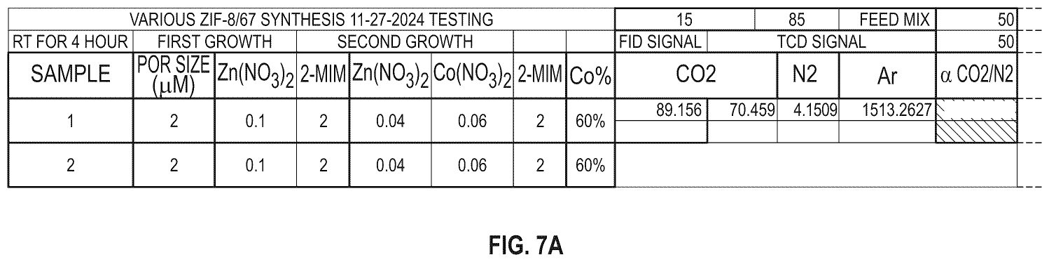

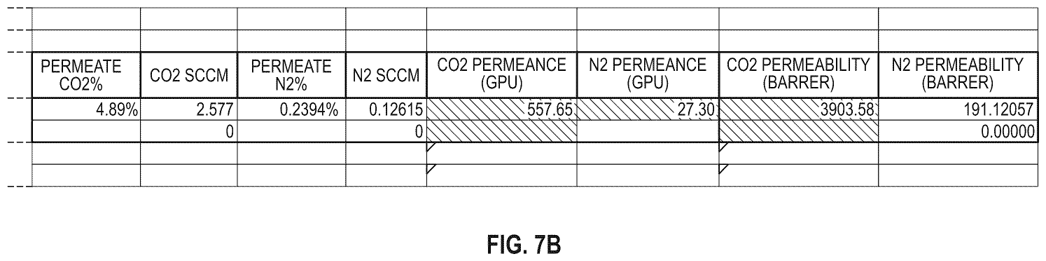

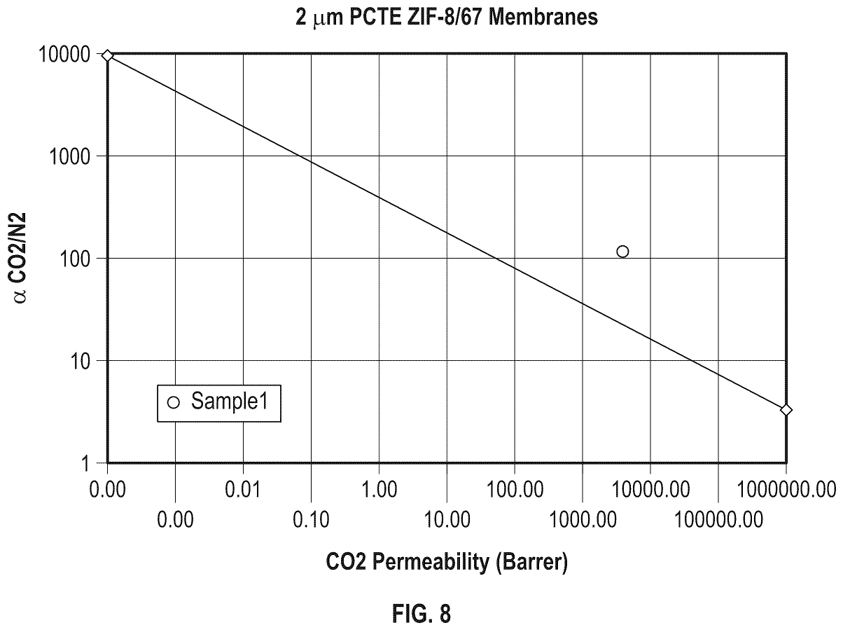

With reference to FIGS. 7 and 8, the PCTE Membranes featured 2000 nm pores. As shown in the table of FIG. 7, the CO₂ permeability was 115.73988 for sample 1, exceeding the Robeson upper boundary as shown in the plot of FIG. 8.

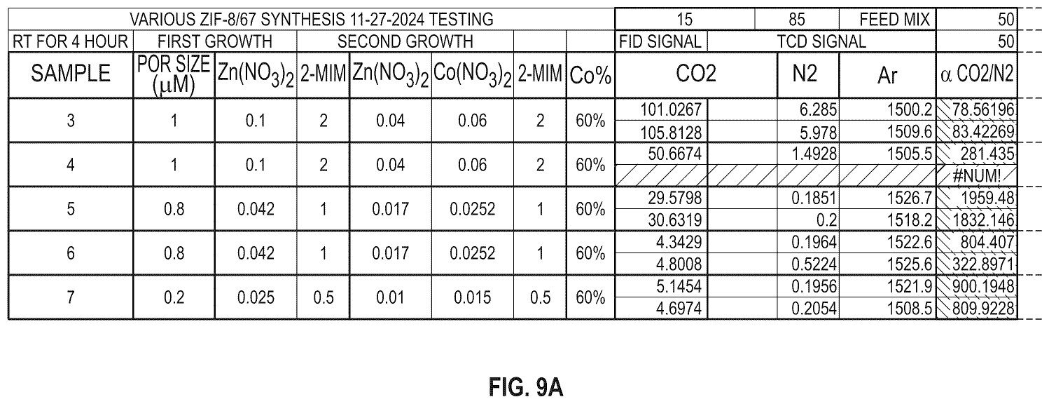

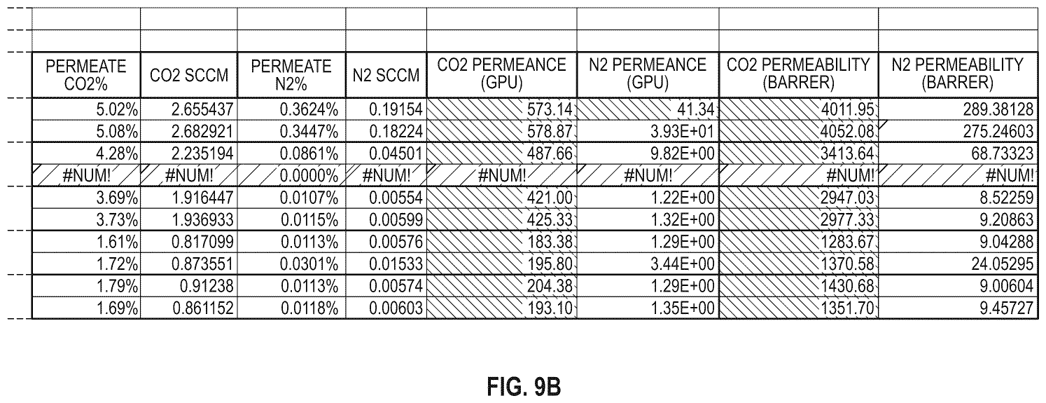

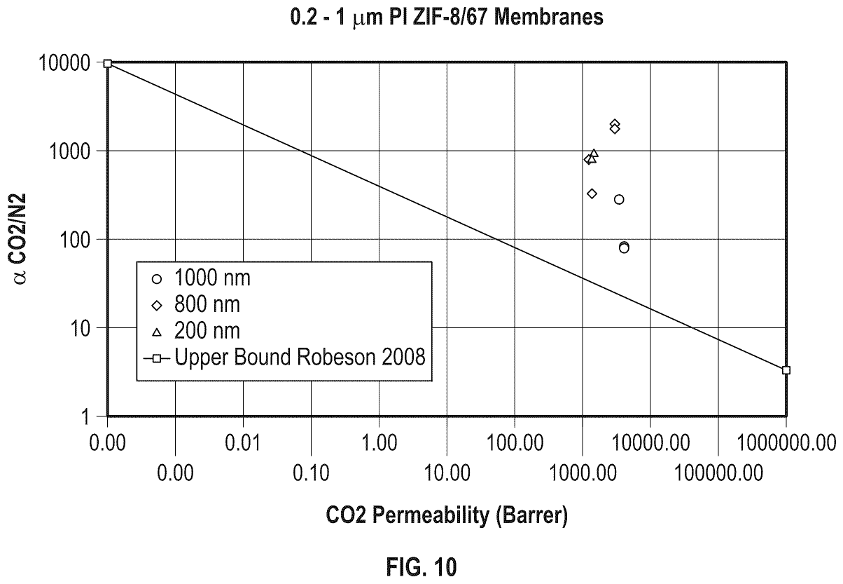

With reference to FIGS. 9 and 10, the Polyimide Membranes featured 100 nm pores. As shown in the plot of FIG. 10 (based on the experimental data set forth in the table of FIG. 9), the CO₂ permeability uniformly exceeded the Robeson upper bound.

In aspects, a polymeric substrate is utilized in fabricating a composite membrane. The polymeric substrate is a polymer-based material that serves as the foundation for additional processing, coating and/or functionalization of the composite membrane. In an aspect, track etched polycarbonate (PCTE), polyester (PETE) and/or polyimide (PI) polymeric substrates may be used as a template to support trans-membrane growth of metal-organic framework (MOF) material(s), e.g., by way of interfacial synthesis. The polymeric substrates generally define a plurality of pores that extend therethrough. The pores may be of various pore sizes and, for a specific polymeric substrate, may be of uniform or non-uniform diameter.

In aspects, a metal ion solution is utilized for interfacial synthesis of a metal-organic framework (MOF) within pores of the polymeric substrate. The metal ion solution may take the form of a water-based solution with metal ions dissolved therewithin. In aspects, zinc and/or cobalt may be utilized as the metal ions for interfacial synthesis of the MOF within pores of a polymeric substrate. Alternative metal ions may be employed, provided the metal ions are used with an organic ligand solution that supports interfacial synthesis of a MOF within the pores of a polymeric substrate. The metal ions are generally dissolved in deionized water and may be used at various metal ion concentrations for purposes of interfacial synthesis.

In aspects, an organic ligand solution is utilized for interfacial synthesis of a metal-organic framework (MOF) within pores of the polymeric substrate. The organic ligand solution may take the form of an organic linker chemical dissolved in an organic solvent. In aspects and by way of example, 2-methylimidazole may be dissolved in 1-octanol to form the organic ligand solution. Alternative organic linker chemicals and/or alternative organic solvents may be employed, provided the organic linker chemical/organic solvent supports interfacial synthesis of a MOF within pores of a polymeric substrates. The organic ligand solution may be used at various organic linker chemical concentrations for purposes of interfacial synthesis.

In an aspect, the aqueous solutions containing Zn²⁺ and Co²⁺ ions may have various counterions, including the following non-limiting examples: NO³⁻, SO₄²⁻, Br⁻, Cl⁻, I⁻, PO₄³⁻, ClO₄⁻, PF₆⁻, CH₃COO⁻, and HCOO⁻. The concentrations of the aqueous solutions may range, for example, from 0 to 0.1 M for each metal ion. The PCTE template may include track-etched pore diameters of varying sizes, including the following non-limiting pore diameters: 10 nm, 30 nm, 50 nm, 100 nm, 200 nm, 800 nm, 1 μm, 2 μm, 10 μm, and 20 μm.

The PCTE templates may be fabricated from various materials, e.g., polycarbonate materials (Sterlitech Corporation), polyester materials (Sterlitech Corporation) and polyimide materials (it4ip S.A).

The period of time that the template is allowed to float for purposes of the interfacial synthesis is generally selected to ensure effective synthesis.

In an aspect, organic ligands in 1-octanol, 1-hexanol, or 1-butanol with concentration ranging from 0.1 to 1.0 M is added to form a clear interface without apparent agitation or mixing. The membrane may be left standing still for 5 minutes to 8 hours before being taken out and washed with DI water. The membrane may then be flipped, i.e., a previously organic facing side may now be placed on top of another aqueous solution containing Zn²⁺ and Co²⁺ ions (counterions being, for example NO₃⁻, SO₄²⁻, Br⁻, Cl⁻, I⁻, PO₄³⁻, ClO₄⁻, PF₆⁻, CH₃COO⁻, or HCOO⁻) with concentrations ranging from 0 to 0.1 M for each metal ion.

The membrane may be left floating between 4 and 72 hours before a 2-MIM solution in 1-octanol, 1-hexanol, or 1-butanol with concentration ranging from 0.1 to 1.0 M is added to form a clear interface without apparent agitation or mixing. The membrane may be left standing still for 5 minutes to 8 hours before being taken out, washed with DI water, and air-dried for 24 hours, thereby providing a composite membrane through interfacial synthesis.

Determination of residual N₂ concentration in Argon: Using an Allicat MC-500 series mass flow meter, pure argon at 50 sccm was connected directly to the Gas Chromatograph and run 10 times. Averaged integrations of the Ar and N₂ signals in the GC chromatograms were used to determine the residual N₂ concentrations in Ar.

Calibration Curve Construction: In a mixing loop, low flow Allicat MC-5 series mass flow meters were used to control the concentration of mixed gases, i.c., CO₂ and N₂, at low concentrations by varying the flow rates of the gases in a mixture, with Argon flow rate fixed at 50 sccm. The mixture gases were fed into a GC and integrations of signals corresponding to Ar, N₂, and CO₂ were recorded and plotted against feed compositions to obtain the calibration curve. In the curve for N₂ calibration, the integration was set to the value corresponding to the residual N₂ concentration in Ar for the point of zero N₂ feed.

### Sample Synthesis Conditions

Sample 0—Pure argon injection to determine the N₂ contamination which was determined to be 0.36 GPU.
Sample 1—A blank PCTE membrane that underwent no synthetic conditions was used for baseline testing.
Sample 2—In a 20 mL glass vial, 4 mL of 0.0125 M Zn(NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed to stand for 4 hours. The membrane was taken out with a tweezer, rinsed with DI water and air-dried for 24 h before further analysis.
Sample 3—In a 20 mL glass vial, 4 mL of DI water was added without Zn(NO₃)₂. A 30 nm PCTE template was placed on top and left floating for 1 hour. No initial ligand was applied. The membrane was then laid on top of 4 mL 0.00075 M Zn(NO₃)₂ and 0.00175 M Co(NO₃)₂ in DI water in another vial. After 48 hours, 3 mL of 0.25 M 2-MIM in 1-octanol was added. After another 4-hour standing period, the membrane was removed, rinsed with DI water, and air-dried for 24 h before further analysis.
Sample 4—In a 20 mL glass vial, 4 mL of 0.0125 M Zn (NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed standing for 4 hours. The membrane was taken out with a tweezer, rinsed with DI water, and laid on top of 4 mL 0.0025 M Co(NO₃)₂ in DI water in another 20 mL glass vial. The membrane was allowed standing for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.
Sample 5—In a 20 mL glass vial, 4 mL of 0.0125 M Zn (NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed to stand for 4 hours. The membrane was taken out with a tweezer, rinsed with DI water, and laid on top of 4 mL 0.00045 M Zn(NO₃)₂ and 0.00105 M Co(NO₃)₂ in DI water in another 20 mL glass vial. The membrane was allowed to stand for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.
Sample 6—In a 20 mL glass vial, 4 mL of 0.0125 M Zn(NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed standing for 4 hours. The membrane was taken out with a tweezer, rinsed with DI water, and laid on top of 4 mL 0.0005 M Zn(NO₃)₂ and 0.002 M Co(NO₃)₂ in DI water in another 20 mL glass vial. The membrane was allowed to stand for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.
Sample 7—In a 20 mL glass vial, 4 mL of 0.0125 M Zn(NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed standing for 4 hours. The membrane was taken out with a tweezer, rinsed with DI water, and laid on top of 4 mL 0.00075 M Zn(NO₃)₂ and 0.0035 M Co(NO₃)₂ in DI water in another 20 mL glass vial. The membrane was allowed to stand for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.
Sample 8—In a 20 mL glass vial, 4 mL of 0.0125 M Zn(NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed to stand for 4 hours. The membrane was taken out with a tweezer, rinsed with DI water, and laid on top of 4 mL 0.001 M Zn(NO₃)₂ and 0.0015 M Co(NO₃)₂ in DI water in another 20 mL glass vial. The membrane was allowed to stand for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.
Sample 9—In a 20 mL glass vial, 4 mL of 0.0125 M Zn(NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed to stand for 4 hours. The membrane was taken out with a tweezer, rinsed with DI water, and laid on top of 4 mL 0.00125 M Zn(NO₃)₂ and 0.00125 M Co(NO₃)₂ in DI water in another 20 mL glass vial. The membrane was allowed to stand for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.
Sample 10—In a 20 mL glass vial, 4 mL of 0.0125 M Zn(NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed to stand for 4 hours. The membrane was taken out with a tweezer, rinsed with DI water, and laid on top of 4 mL 0.0015 M Zn(NO₃)₂ and 0.0035 M Co(NO₃)₂ in DI water in another 20 mL glass vial. The membrane was allowed to stand for 48 hours before a 3 mL solution of 0.5 M 2-MIM in 1-octanol was added on top. The system was left standing for 4 hours before removing the membrane with a tweezer, which was subsequently washed with DI water and air-dried for 24 h before further analysis.
Sample 11—In a 20 mL glass vial, 4 mL of 0.0125 M Zn(NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed to stand for 4 hours. The membrane was taken out with a tweezer, rinsed with DI water, and laid on top of 4 mL 0.0015 M Zn(NO₃)₂ and 0.0035 M Co(NO₃)₂ in DI water in another 20 mL glass vial. The membrane was allowed to stand for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.
Sample 12—In a 20 mL glass vial, 4 mL of 0.0125 M Zn(NO₃)₂ in DI water was added. A 30 nm PCTE template was placed on top of the water solution and left floating for 1 hour. Then, 3 mL 0.25 M 2-MIM in 1-octanol was added on top of the template and water solution in order to form a clear interface without obvious agitation. The entire system was allowed to stand for 4 hours. The membrane was taken out with a tweezer, rinsed with DI water, and laid on top of 4 mL 0.0015 M Zn(NO₃)₂ and 0.0035 M Co(NO₃)₂ in DI water in another 20 mL glass vial. The membrane was allowed to stand for 48 hours before a 3 mL solution of 0.125 M 2-MIM in 1-octanol was added on top. The system was left standing for 4 hours before removing the membrane with a tweezer, which was subsequently washed with DI water and air-dried for 24 h before further analysis.
Sample 13—In a 20 mL glass vial, 4 mL of 0.0125 M Zn(NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed to stand for 4 hours. The membrane was taken out with a tweezer, rinsed with DI water, and laid on top of 4 mL 0.0025 M Zn(NO₃)₂ and 0.0025 M Co(NO₃)₂ in DI water in another 20 mL glass vial. The membrane was allowed to stand for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.
Sample 14—In a 20 mL glass vial, 4 mL of 0.0125 M Zn(NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed to stand for 4 hours. The membrane was taken out with a tweezer, rinsed with DI water, and laid on top of 4 mL 0.005 M Zn(NO₃)₂ and 0.01 M Co(NO₃)₂ in DI water in another 20 mL glass vial. The membrane was allowed to stand for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.
Sample 15—In a 20 mL glass vial, 4 mL of 0.015 M Zn(NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed to stand for 4 hours. The membrane was taken out with a tweezer, rinsed with DI water, and laid on top of 4 mL 0.005 M Zn(NO₃)₂ and 0.01 M Co(NO₃)₂ in DI water in another 20 mL glass vial. The membrane was allowed to stand for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.
Sample 16—In a 20 mL glass vial, 4 mL of 0.0175 M Zn(NO₃)₂ in DI water was added. A 30 nm PCTE template was placed on top of the water solution and left floating for 1 hour. Then, 3 mL 0.5 M 2-MIM in 1-octanol was added on top of the template and water solution in order to form a clear interface without obvious agitation. The entire system was allowed to stand for 4 hours. The membrane was taken out with a tweezer, rinsed with DI water, and laid on top of 4 mL 0.005 M Zn(NO₃)₂ and 0.01 M Co(NO₃)₂ in DI water in another 20 mL glass vial. The membrane was allowed to stand for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.
Sample 17—In a 20 mL glass vial, 4 mL of 0.0125 M Zn(NO₃)₂ in DI water was added. A 30 nm PCTE template was placed on top of the water solution and left floating for 1 hour. Then, 3 mL 0.25 M 2-MIM in 1-octanol was added on top of the template and water solution in order to form a clear interface without obvious agitation. The entire system was allowed to stand for 4 hours. The membrane was taken out with a tweezer, rinsed with DI water, and laid on top of 4 mL 0.006 M Zn(NO₃)₂ and 0.0014 M Co(NO₃)₂ in DI water in another 20 mL glass vial. The membrane was allowed to stand for 48 hours before a 3 mL solution of 0.25 M 2-MIM in 1-octanol was added on top. The system was left standing for 4 hours before removing the membrane with a tweezer, which was subsequently washed with DI water and air-dried for 24 h before further analysis.

### Continuous/Semi-Continuous Synthesis

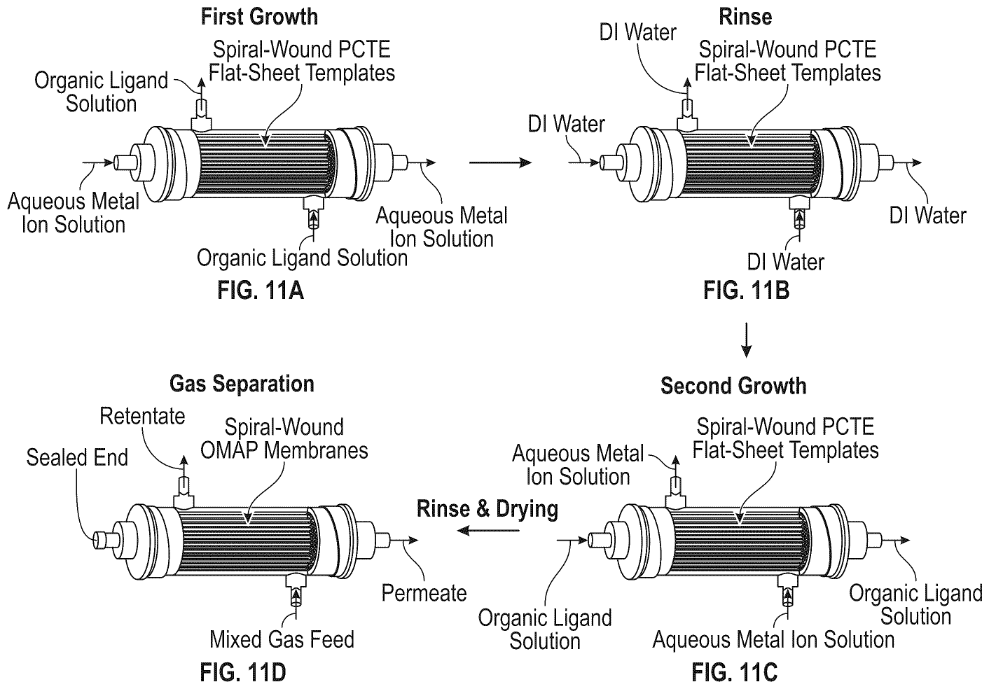

In aspects, the templated interfacial synthesis of Ordered Metal Organic Framework Polymer Membranes is scalable, e.g., to meet standards of industrial applications. As schematically depicted in FIGS. 11A-11D, commercially available PCTE templates come in large flat sheets with customizable sizes, which allows facile manufacturing into spiral-wound modules. Such modules may be used in interfacial synthesis by precisely controlling the solution identities and qualities on either side of the templates, in either static or flow-through modes.

During a first growth (FIG. 11A), aqueous metal ion solutions may fill one-side of the templates, e.g., using horizontal ports, while organic ligand solutions fill the other side, e.g., using the vertical ports. After pre-determined reaction times, the solutions may be drained and the templates may be rinsed with DI water on both sides, e.g., through all four ports (FIG. 11B).

The module may then be subjected to a second growth by filling in aqueous metal ion solutions through the vertical ports (in the schematically depicted embodiment) and organic ligand solutions through the horizontal ports (in the schematically depicted embodiment) (FIG. 11C). After pre-determined reaction times, the module may again be rinsed with DI water and air-dried, e.g., using the ports.

After the synthesis steps, one of the ports, e.g., one of the horizontal ports, may be sealed, and the spiral-wound composite membrane module is ready for gas separation applications, where mixed gases may be fed through one of the vertical ports and leave the other as retentate, while desired permeate may be collected through the open horizontal port (FIG. 11D).

### Membrane Fabrication and End Use Applications

Membranes fabricated using templated interfacial synthesis as disclosed herein is highly adaptive and can be fabricated using (i) a wide-range of nano/micro-porous polymer templates, and (ii) employing a plethora of metal ions and organic ligands. In aspects, the interfacial synthesis techniques and modalities described herein support applications in which MOF framework preparation is achieved using a variety of combinations of nano/micro-porous polymer templates, metal ions and organic ligands, including specifically nano/micro-porous polymer templates, metal ions and organic ligands that have been previously disclosed in the literature.

Membranes fabricated using templated interfacial synthesis as disclosed herein is highly adaptive and can be applied to construct/assemble a broad range of end products. In aspects, composite membranes fabricated according to the present disclosure may be incorporated, for example, into flat-sheet or spiral-wound modules that can be fit into existing or new gas separation facilities, including flue gas sorption plants, direct air capture plants, natural gas sweetening pipelines, and olefin/paraffin separation towers. Additional applications and deployments that stand to benefit from the gas separation capabilities of the disclosed composite membranes are expressly incorporated within the scope hereof.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

What is claimed is:

1. A composite membrane, comprising:
a. a polymeric substrate that defines a plurality of pores that extend therethrough; and
b. a metal organic framework comprising one or more interfacially synthesized components formed within the plurality of pores;
wherein the one or more interfacially synthesized components include (i) a first interfacially synthesized component formed from synthesis of a first aqueous metal ion solution including a single metallic ion and a first organic ligand solution, and (ii) optionally, a second interfacially synthesized component formed from synthesis of a second aqueous metal ion solution and a second organic ligand solution.

2. The composite membrane of claim 1, wherein the polymeric substrate is a track-etched polymer template.

3. The composite membrane of claim 1, wherein at least one of the first organic ligand solution and the optional second organic ligand solution comprises a 2-methylimidazole (2-MIM) solution.

4. The composite membrane of claim 1, wherein at least one of the first aqueous metal ion solution and the second aqueous metal ion solution includes at least one of Zn ions and Co ions.

5. The composite membrane of claim 4, wherein at least one of the first aqueous metal ion solution and the optional second aqueous metal ion solution includes a metallic counterion selected from the group consisting of NO³⁻, SO₄²⁻, Br⁻, Cl⁻, I⁻, PO₄³⁻, ClO₄⁻, PF₆⁻, CH₃COO⁻, and HCOO⁻.

6. The composite membrane of claim 1, wherein at least one of the first aqueous metal ion solution and the second aqueous metal ion solution includes bimetallic ions.

7. The composite membrane of claim 1, wherein the polymeric substrate is fabricated from a polycarbonate material, a polyester material or a polyimide material.

8. The composite membrane of claim 1, wherein the plurality of pores has a diameter selected from the group consisting of 10 nm, 30 nm, 50 nm, 100 nm, 200 nm, 800 nm, 1 μm, 2 μm, 10 μm, and 20 μm.

9. The composite membrane of claim 1, wherein the composite membrane is a sheet or a spiral wound membrane.

10. A method for membrane synthesis, comprising:
a. providing a polymeric substrate that defines a plurality of pores that extend therethrough;
b. initiating a first growth phase by exposing a first surface of the polymeric substrate to a first aqueous metal ion solution, and exposing a second surface of the polymeric substrate opposite the first surface to a first organic ligand solution; and
c. optionally initiating a second growth phase by exposing the first surface of the polymeric substrate to a second organic ligand solution, and exposing a second surface of the polymeric substrate opposite the first surface to a second aqueous metal ion solution,
wherein the first growth phase and, optionally, the second growth phase effectuate interfacial synthesis of a metal organic framework (MOF) within the plurality of pores.

11. The method of claim 10, further comprising rinsing and drying the polymeric substrate between the first growth phase and the optional second growth phase.

12. The method of claim 10, wherein the first aqueous metal ion solution and the optional second aqueous metal ion solution include the same metal ions in solution.

13. The method of claim 10, wherein the first organic ligand solution and the optional second organic ligand solution include the same organic linker chemical(s) in solution.

14. The method of claim 10, wherein the first aqueous metal ion solution in the first growth phase includes a single metal ion, and wherein the second aqueous metal ion solution in the optional second growth phase is bimetallic.

15. The method of claim 10, wherein the polymeric substrate is positioned within a reaction chamber during the first growth phase and the optional second growth phase, and wherein the reaction chamber includes a plurality of ports that permit introduction and withdrawal of the first aqueous metal ion solution, the optional second aqueous metal ion solution, the first organic ligand solution and the optional second organic ligand solution therefrom.

16. The method of claim 10, wherein the first growth phase and the second growth phase yield a composite membrane.

17. A method for separating gases, comprising:
a. exposing a composite membrane according to claim 1 to a mixture of gases; and
b. separating a first gas included in the mixture of gases from a second gas included in the mixture of gases by molecular sieving of the first gas from the second gas with the composite membrane.

18. A module for use in a gas separation application, comprising:
a. a housing; and
b. a composite membrane positioned within the housing, wherein the composite membrane comprises:
i. a polymeric substrate that defines a plurality of pores that extend therethrough; and
ii. a metal organic framework comprising one or more interfacially synthesized components formed within the plurality of pores;
wherein the one or more interfacially synthesized components include (i) a first interfacially synthesized component formed from synthesis of a first aqueous metal ion solution including a single metallic ion and a first organic ligand solution, and (ii) optionally, a second interfacially synthesized component formed from synthesis of a second aqueous metal ion solution and a second organic ligand solution.

19. The module of claim 18, wherein the polymeric substrate is a track-etched polymer template.

20. The module of claim 18, wherein at least one of the first organic ligand solution and the optional second organic ligand solution comprises a 2-methylimidazole (2-MIM) solution, and wherein at least one of the first aqueous metal ion solution and the optional second aqueous metal ion solution includes at least one of Zn ions and Co ions
